(19) United States
(12) Patent Application Publication
(10) Pub. No.: US 2018/0242796 A1
(43) Pub. Date: Aug. 30, 2018

(54) SCRUBA-DUB-DUB

(71) Applicant: Marcus Moffitt, Riverside, CA (US)

(72) Inventor: Marcus Moffitt, Riverside, CA (US)

(21) Appl. No.: 15/444,858

(22) Filed: Feb. 28, 2017

(51) Int. Cl. A47K 7/04; A47K 7/03; B25G 1/04; A46B 13/04; A46B 13/00; A41D 19/00; A46B 15/00; A46B 7/04

(52) U.S. Cl. CPC A47K 7/04; A47K 7/03; B25G 1/04; A46B 13/04; A46B 15/0006; A41D 19/0093; A46B 15/0095; A46B 7/04; A46B 13/008

(57) ABSTRACT

A main body including a top portion and a bottom portion; a battery housed in an electronical housing located on the top portion of the main body; a plurality of detachable brushes attached to the bottom portion, the plurality of detachable brushes including a circular ring of soft bristles and a circular ring of firm bristles; the plurality of detachable brushes are rotatable at different speeds and orientations via power from the battery; a glove attached to the top portion of the main body; a first reservoir for housing gel soap; a second reservoir for housing face soap, wherein the second reservoir is smaller than the first reservoir; a first inlet and a second inlet connected to the first and second reservoir respectively; and an outlet dispenser from the first and second reservoir at a center location of the bottom portion to dispense the gel soap and the face soap when a first and second button is actuated respectively.

### CROSS-REFERENCE TO RELATED APPLICATIONS

N/A

### BACKGROUND OF THE INVENTION

### Field of the Invention

The present invention generally relates to a back scrubber. More particularly, the present invention relates to an extendable back scrubber which is battery powered, attachable to hands, dispenses soap, uses rotatable brushes and allows a user to conveniently and effectively scrub spots not easily reached on the back of the user's body.

### Background of the Invention

Scrubbing the body surface provides effective cleaning of dirt and dry skin from the body. Many cleaning devices have been developed and used to scrub human body. Such cleaning devices include sponges, brushes, loofahs, washcloths and other devices. Some of them are designed to perform scrubbing of sensitive skin such as on face at low pressure while some other devices have been designed to perform scrubbing of skin on other body parts at normal pressure or high pressure as required. Some devices have also been provided to help a user to scrub areas of the body that are difficult to reach, such as human back. For example, U.S. Pat. No. 6,015,242 issued to Christopher S. Gillis on 2000, Jan. 18, discloses a body cleansing puff which stores a solid soap and produces of soap lather. Similarly, U.S. Pat. No. 8,814,457 issued to Judy Austin and Jack Austin on 2014, Aug. 26, discloses a device for holding soap and allowing user to scrub his/her body. Similarly, U.S. Pat. No. 5,504,963 issued to Bynum Concepts, Inc. on 1996, Apr. 9, discloses an elongated device for scrubbing body, preferably a person's back. These scrubbing devices suffer from one limitation or other. A device suitable for scrubbing at high pressure is not suitable for scrubbing face. Hence, it is desired to provide a scrubbing device which is suitable for cleaning entire body including the face. Also, these devices also does not allow efficient scrubbing of back as even with an elongated scrubbing device some parts of back cannot be completely scrubbed due to the angle of the scrubbing device when in use. Hence, it is desired that the scrubbing device allows convenient and effective cleaning of a user's back where some parts are difficult to be reached. It is further desired that scrubbing device employs a mechanism to perform scrubbing with brushes which can be rotated at different speeds and orientations. Furthermore, it is desired that the scrubbing device can be attached to hands for effective handling of the scrubbing device during use.

It is an aspect of the invention to overcome or alleviate a problems and disadvantages of the prior art. Consequently, there is a need for a scrubbing device for effective cleaning of body parts including face and back.

### BRIEF SUMMARY OF THE INVENTION

In one embodiment of the present invention, a back scrubber apparatus is provided, comprising: a main body including a top portion and a bottom portion; a battery housed in an electronical housing located on the top portion of the main body; a plurality of detachable brushes attached to the bottom portion, the plurality of detachable brushes including a circular ring of soft bristles and a circular ring of firm bristles; the plurality of detachable brushes are rotatable at different speeds and orientations via power from the battery; a glove attached to the top portion of the main body; a first reservoir for housing gel soap; a second reservoir for housing face soap, wherein the second reservoir is smaller than the first reservoir; a first inlet and a second inlet connected to the first and second reservoir respectively; and an outlet dispenser from the first and second reservoir at a center location of the bottom portion to dispense the gel soap and the face soap when a first and second button is actuated respectively.

In one embodiment, an extendable handle is provided, wherein the extendable handle includes multiple tube members telescopically arranged. In one embodiment, a locking mechanism to lock a length of the extendable handle at a desired length is provided. In another embodiment, an angle locking mechanism to lock an angle of the extendable handle at a desired angle is provided.

In one embodiment, a control mechanism is provided to control the speed, orientation, and rotation of the plurality of detachable brushes. In one embodiment, the glove includes open fingers such that fingers of a user are exposed. In another embodiment, the glove is constructed from a rubber material. In yet another embodiment, a number of Velcro straps is provided to provide the user with a means for tightening and adjusting the fit in the glove.

In one embodiment, the main body is transparent. In one embodiment, the main body is constructed of a flexible plastic. In one embodiment, a hanging element is provided, wherein the hanging element is secured to the top portion of the main body to permit a user to hang the back scrubber apparatus on a hook, shower head, handle, shower rack or other object for drying and storage purposes

### BRIEF DESCRIPTION OF THE SEVERAL VIEWS OF THE DRAWINGS

It is to be understood that the drawings are to be used for the purposes of exemplary illustration only and not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments. Referring to the drawings in which like reference character(s) present corresponding part(s) throughout:

FIG. 1 shows a top perspective view of an extendable back scrubber according to an embodiment of the present invention;

FIG. 2 shows a bottom perspective view of an extendable back scrubber according to an embodiment of the present invention;

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

Accordingly, it is a primary object of the present invention to provide an extendable back scrubber which can be attached to hands, dispenses soap, uses rotatable brushes and allows a user to conveniently and effectively scrub spots not easily reached on the back of his/her body.

It is another object of the present invention to provide an extendable back scrubber which further includes detachable brushes which can be easily attached, detached and replaced when damaged from usage.

It is another object of the present invention that the detachable brushes of the extendable back scrubber include both softer bristles and firm bristles which allows scrubbing of the face and the body respectively.

It is yet another object of the present invention that the detachable brushes of the extendable back scrubber are rotatable for effective scrubbing.

It is yet another object of the present invention that the speed and orientation of the rotation of the detachable brushes of the extendable back scrubber is controlled.

It is yet another object of the present invention that the extendable back scrubber includes an open finger rubber glove attached to the top part of the extendable back scrubber for inserting hands inside the glove for efficiently operating the extendable back scrubber.

It is yet another object of the present invention that the extendable back scrubber includes an extendable handle which allow an increase of the length of the handle to allow user reach his/her back easily. A locking mechanism is provided to lock the length of the handle at desired length.

It is yet another object of the present invention that the extendable back scrubber includes an angle locking mechanism which locks in the handle at an obtuse angle with respect to the main body of the extendable body scrubber to allow the user to effectively scrub spots not easily reached on his/her back.

It is yet another object of the present invention that the extendable back scrubber includes batteries for automated operation of the extendable back scrubber.

It is yet another object of the present invention that the extendable back scrubber is available both as a right handed version as well as a left handed version.

It is still another object of the present invention that the extendable back scrubber is available in large, medium, small and miniature version.

Other objects of the present invention will become apparent from time to time throughout the specification as hereinafter related. Embodiments of the present invention provide an extendable back scrubber which is battery powered, attachable to hands, dispenses soap, uses rotatable brushes and allows a user to conveniently and effectively scrub spots not easily reached on the back of his/her body. Accordingly, the specific embodiments discussed herein are merely illustrative of specific manners in which to make and use this invention, and are not intended to represent an exhaustive list of all possible structure and processes of the present invention.

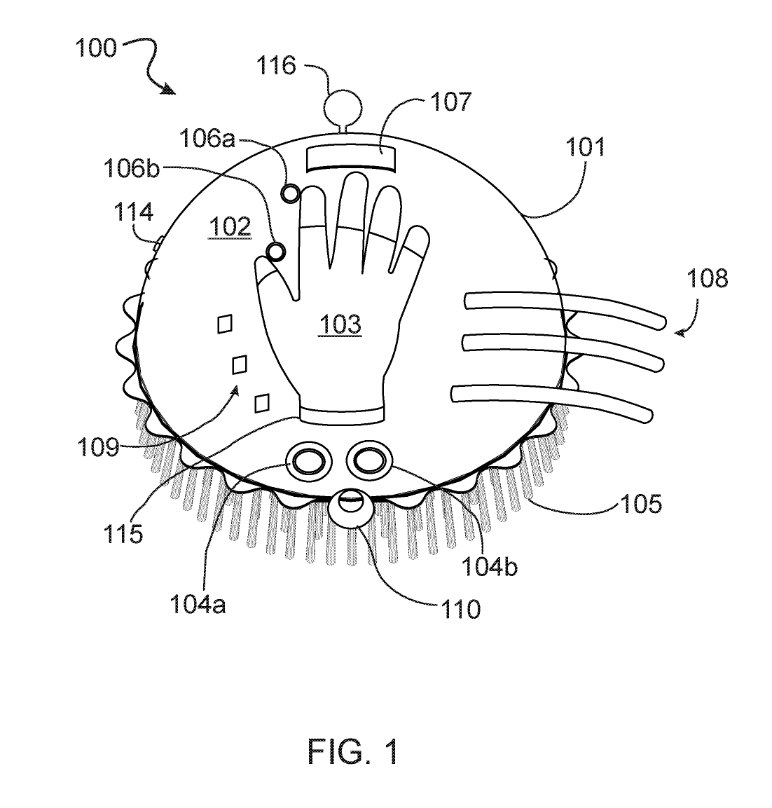

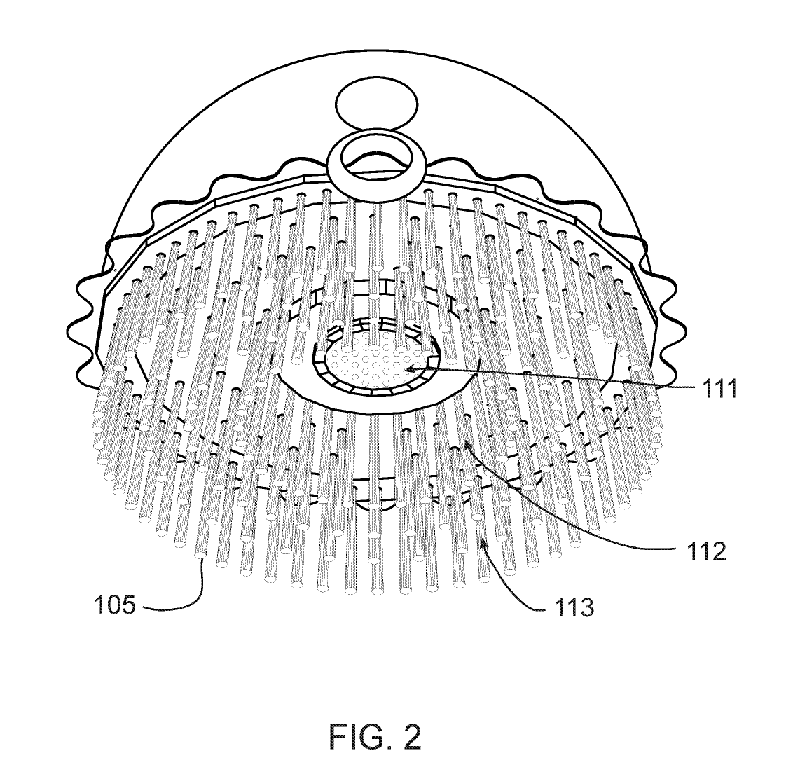

Now referring to the drawing, an extendable back scrubber 100 of the present invention is shown in FIGS. 1-2. The present invention is generally directed to a battery powered automatic body scrubber which is attachable to hands, dispenses soap, use rotatable brushes and allows a user to conveniently and effectively scrub spots not easily reached on the back of his/her body. The extendable back scrubber is designed for effective cleaning of dirt and dry skin from the face, the back and other parts of the body.

In one embodiment, the extendable back scrubber of the present invention comprises a main body 101 that houses a reservoir storing gel soap and another reservoir storing face soap. A divider inside the main body separates the gel soap reservoir and the face soap reservoir. A first inlet 104a of the gel soap reservoir is present on a top surface 102 of the main body to allow filling the gel soap in the gel soap reservoir. Similarly, a second inlet 104b of the face soap reservoir to allow filling the face soap reservoir. The first and second inlets are preferably covered with a cover which can be lifted up to put the soaps in the reservoirs. In a preferred embodiment of the present invention, there is a single opening on the surface of the top of the main body which is separated into two sub openings by the divider which divides the face soap reservoir and the gel soap reservoir. A single cover covers the two sub openings while one sub opening allows filling face soap in face soap reservoir while another sub opening allows filling gel soap in gel soap reservoir. The gel soap reservoir and face soap reservoir are preferably present on the right on the top half sphere of the main body. In the embodiment with a single opening only one inlet 104a or 104b is present. Ideally, the single opening is centered under glove 103. The glove will be described in greater detail below.

In one embodiment, the whole top sphere of the main body is preferably a clear casing to allow the user to monitor the amount of the soap present in the reservoir and/or reservoirs. In one embodiment, the face soap reservoir is smaller than the gel soap reservoir to allow more gel soap to be filled in the gel soap reservoir for use on the body. An outlet dispenser 111 from the two reservoirs open up at a center location of the bottom of the main body to dispense the face soap and gel soap when the release of the face soap and gel soap is actuated. The release of the face soap is actuated by a first button 106a which, when pressed dispenses the face soaps through the dispenser. The first button for dispensing face soap is preferably positioned so as to be pressed by the index finger of the hand inserted in the glove. The release of the gel soap is actuated by a second button 106b which, when pressed dispenses the gel soap through the dispenser. The second button for dispensing gel soap is preferably positioned on the top of the main body so as to be pressed by the thumb of the hand inserted in the glove.

In one embodiment, the main body further has detachable brushes 105 attached to the bottom of the main body. The brushes can be attached and detached. This is a particular advantage of the present invention, since if the brushes are damaged from usage; they can be replaced with fresh brushes. In one embodiment, the detachable brushes preferably consist of bristles arranged in a spiral arrangement. The spiral arrangement is helpful in proper scrubbing the entire skin the bottom of the main body covers. The spiral arrangement of the brushes is divided into two parts, inner layers and outer layers. The inner layers of the spiral arrangement include soft bristles 112 which allow the inner layer to function as a facial scrubber. The soft bristles are suitable for cleaning the dirt and dry skin off the face's new skin beneath. The soft bristles in the inner layers preferably form an inch thick layer. The soft bristles are preferably about one inch long. The outer layers of the spiral arrangement include firm bristles 113 which allow the outer layer to function as a body scrubber. The firm bristles are preferably made of firm nylon which is good for the skin. The firm bristles help in scrubbing the dirt and dry skin off the body's new skin beneath. The firm bristles in the outer layer preferably form an inch thick layer. Each of the inner layers and the outer layers are preferably one inch wide. The inner layers of the soft bristles are present up to about four inches from the center of the bottom of the main body while the outer layers of the firm bristles cover about 3 inches from the edge of the inner layers to the circumference of the extendable back scrubber. The replaceable brushes are attached to the bottom of the main body by twisting and locking in after properly aligned. Both the soft bristles as well as firm bristles can rotate. These bristles can rotate clockwise, counterclockwise and quarter turns left and right, back and forth around the center of the bottom of the main body where the soap is dispensed. Control mechanisms 114 are provided in the extendable back scrubber to control the speed and orientation of the rotation of the brushes. In a preferred embodiment of the present invention, one switch is provided on the extendable back scrubber for setting the rotational speed of the bristles as slow, medium and fast while another switch is provided on the extendable back scrubber for setting the orientation of the rotation of the bristles as clockwise, counterclockwise, and quarter turns left and right, back and forth. The switches are connected to the wiring and mechanical structures within the main body. The switches are preferably present on the side of the top half of the extendable back scrubber.

In one embodiment, an open finger rubber glove 103 is attached to the top part of the extendable back scrubber. The open finger rubber glove is preferably attached with a strong means of attachment. The means of attachment is preferably a strong adhesive. The open finger rubber glove is attached so strongly so as not to allow it to come off or be detached in any manner at all. On the top half off to the right side of the extendable back scrubber, Velcro straps 108, preferably three in number, are provided that can reach across the glove into a loop 109 and back over the hand to be attached against itself and can be tightened and adjusted to hands unfit for the glove. A hand strap 115 is also provided for supporting the hand inserted in the glove. In one embodiment, the extendable back scrubber has a full glove in place of an open finger rubber glove as illustrated. The clear see through top cover and the open finger glove allows users with larger fingers to use the extendable back scrubber as well and also to allow the hand to breath.

In one embodiment, the extendable back scrubber includes an extendable handle 110 which can be extended from a range of four inches to one foot preferably increasing 2 inches at a time. Hence, the handle when fully extended is preferably about a foot long. The handle includes multiple tube members telescopically arranged with each other. There are preferably six tube members. Each of the tube members is preferably about two inches long, totaling it about one foot long. There is a locking mechanism at the top of the extendable back scrubber which allows the length of the scrubber to be locked within the total length. There is an angle locking mechanism present in the middle of the extendable back scrubber which allows the locking of a specific angle of the handle with respect to the main body of the extendable back scrubber from 45 degrees to 180 degrees. The ability to lock in the handle at an obtuse angle with respect to the main body of the extendable body scrubber allows the user to effectively scrub spots not easily reached on the users back.

In one embodiment, a small electrical housing 107 is included on the top of the extendable back scrubber which houses the batteries and electric circuit. The entry of the housing has a lid/cover which opens and seals allowing the batteries to be inserted, removed and protected from the water during use. The lid covering the entry of the housing is preferably made from a clear material. In a preferred embodiment of the present invention, the batteries inserted into the housing are visible through the clear dome of the main body. A hanging means 116, such as a rope, is preferably secured to the top of the main body so as to permit a user to hang the extendable back scrubber on a hook, shower head, handle, shower rack or other object for drying and storage purposes until next use. The rope may be made of silk, nylon or any other material. Also, the rope may be elastic, flexible or rigid.

In one embodiment, the extendable back scrubber is preferably about twenty-two inches in circumference. The entire extendable back scrubber is made of a flexible plastic, strong enough to hold components and shape but flexible enough to slightly bend. The extendable body scrubber is available both as a right handed version as well as a left handed version. The extendable body scrubber is provided in different sizes, including large, medium and small. The extendable body scrubber is provided in a miniature version.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

In addition, reference to “first,” “second,” “third,” and etc. members throughout the disclosure (and in particular, claims) are not used to show a serial or numerical limitation but instead are used to distinguish or identify the various members of the group.

What is claimed is:

1. A back scrubber apparatus comprising:
a main body including a top portion and a bottom portion;
a battery housed in an electronical housing located on the top portion of the main body;
a plurality of detachable brushes attached to the bottom portion, the plurality of detachable brushes including a circular ring of soft bristles and a circular ring of firm bristles; the plurality of detachable brushes are rotatable at different speeds and orientations via power from the battery;
a glove attached to the top portion of the main body;
a first reservoir for housing gel soap;
a second reservoir for housing face soap, wherein the second reservoir is smaller than the first reservoir;
a first inlet and a second inlet connected to the first and second reservoir respectively; and
an outlet dispenser from the first and second reservoir at a center location of the bottom portion to dispense the gel soap and the face soap when a first and second button is actuated respectively.

2. The back scrubber apparatus of claim 1, further comprising an extendable handle, wherein the extendable handle includes multiple tube members telescopically arranged,

3. The back scrubber apparatus of claim 2, further comprising a locking mechanism to lock a length of the extendable handle at a desired length.

4. The back scrubber apparatus of claim 2, further comprising an angle locking mechanism to lock an angle of the extendable handle at a desired angle.

4. The back scrubber apparatus of claim 1, further comprising a control mechanism provided to control the speed, orientation, and rotation of the plurality of detachable brushes.

5. The back scrubber apparatus of claim 1, wherein the glove includes open fingers such that fingers of a user are exposed.

6. The back scrubber apparatus of claim 5, wherein the glove is constructed from a rubber material.

7. The back scrubber apparatus of claim 6, further comprising a number of Velcro straps to provide the user with a means for tightening and adjusting the fit in the glove.

8. The back scrubber apparatus of claim 1, wherein the main body is transparent.

9. The back scrubber apparatus of claim 1, wherein the main body is constructed of a flexible plastic.

10. The back scrubber apparatus of claim 1, further comprising a hanging element, wherein the hanging element is secured to the top portion of the main body to permit a user to hang the back scrubber apparatus on a hook, shower head, handle, shower rack or other object for drying and storage purposes.
